(19) United States
(12) Patent Application Publication
(10) Pub. No.: US 2005/0113249 A1
(43) Pub. Date: May 26, 2005

(54) Catalyst for a diesel particulate filter

(76) Inventors: Robin Ziebarth, Midland, MI (US); Cheng G. Li, Troy, MI (US); Ravi Ramanathan, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/995,735

(22) Filed: Nov. 22, 2004

Related U.S. Application Data
(60) Provisional application No. 60/524,470, filed on Nov. 24, 2003.

(51) Int. Cl. B01D 50/00; B01D 53/34; F01N 3/00; B01J 23/00

(52) U.S. Cl. 502/304; 422/177; 422/180

(57) ABSTRACT

A Diesel soot catalyst has ceria and platinum present in a Diesel particulate filter in a ratio, by weight, of ceria to platinum of at most about 75. This catalyst allows for the use of very small amounts of platinum metal while still achieving low balance point temperatures for burning of Diesel soot.

### CROSS-REFERENCE TO RELATED APPLICATION

This application claims the benefit of U.S. Provisional Application Ser. No. 60,524,470, filed Nov. 24, 2003, which is hereby incorporated by reference.

### FIELD OF THE INVENTION

The present invention relates to an improved catalyst for diesel particulate filters.

### BACKGROUND OF THE INVENTION

Diesel engines, because of the way they operate, emit soot particles or very fine droplets of condensate or a conglomerate of the two (particulates) as well as typical harmful gasoline engine exhausts (i.e., HC and CO). These “particulates” (herein Diesel soot), are rich in condensed, polynuclear hydrocarbons, some of which may be carcinogenic.

As the awareness of the danger Diesel soot presents to health collides with the need for greater fuel efficiency that Diesel engines provide, regulations have been enacted curbing the amount of Diesel soot permitted to be emitted. To meet these challenges, soot filters have been used. When using such a filter, the filter must be periodically regenerated by burning off the soot. However, because the temperature where Diesel soot ignites is significantly higher than the normal operating temperature of a Diesel engine, a number of catalysts have been proposed to reduce the ignition temperature of the Diesel soot.

Generally, catalysts containing alkali or alkaline oxides have been used to substantially reduce the Diesel soot ignition temperature significantly as described, for example, in JP 2001-17449; WO 03/011437; US 2002/0132727 and US 2002/0197191. Unfortunately, these catalyst are destructive to the filters resulting in impractical short life times. In addition, these catalysts still have required substantial amounts of noble metal catalysts to reduce the HC and CO gases that are emitted along with the Diesel soot.

Other oxides such as rare earth oxides (e.g., U.S. Pat. No. 4,515,758; US 2002/0197191; US 2002/0044897; US 2003/0124037; WO 01/02083) and base metal oxides have also been used in conjunction with noble metal catalysts to attempt to lower the Diesel soot ignition temperature while also catalyzing the HC and CO emissions. Unfortunately, these catalysts have tended to required substantial amounts of expensive noble metal catalysts and/or rare earth oxides.

Therefore, it would be desirable to provide a catalyst for a Diesel particulate filter that avoids one or more problems of the prior art such as one of the aforementioned problems. In particular, it would be desirable to provide a catalyst that reduces the amount of expensive rare earth oxide and noble metal catalysts that have been required in the prior art.

### SUMMARY OF THE INVENTION

A first aspect of this invention is a catalyst for use in a diesel particulate filter comprising platinum and a cerium oxide wherein the amount, by weight, of platinum present, by volume, in the diesel particulate filter is from about 1 g/ft³ to about 20 g/ft³, the amount, by weight, of cerium oxide present in the diesel particulate filter is at most about 750 g/ft³, and the cerium oxide and platinum are present in a ratio of cerium oxide/platinum of about 10 to about 75 by weight within the diesel particulate filter. Surprisingly, the catalyst composition displays as good or better soot catalysis as demonstrated by the balance point temperature compared to a like catalyst with a greater amount of platinum that falls outside the ceria/platinum ratio. The balance point temperature is the temperature at which the soot burning rate achieved by the Diesel particulate filter is equal to the soot accumulation rate in the filter. Even though it is not understood why this result is obtained, the ratio of ceria to platinum is critical.

A second aspect of the invention is a Diesel exhaust soot reducing system comprised of a Diesel soot filter having the catalyst of the first aspect in said exhaust system. In a preferred embodiment, the Diesel soot filter is located in the exhaust system such that no other catalyst is present upstream (i.e., closer to the Diesel engine) of the Diesel soot filter. The Diesel particulate filter having the catalyst of the present invention used without any catalyst upstream in the exhaust, surprisingly has a balance point temperature essentially the same or lower than a catalyst having much greater amounts of platinum, but the same amount of ceria when tested in a like manner. As such, the present invention does not require a Diesel oxidation catalyst located upstream from the Diesel soot filter, thus reducing the cost and complexity of the emission reduction system, while still using very small amounts of Pt.

The catalyst on a diesel particulate trap may be used in any application where Diesel soot or soot of a similar nature is to be filtered from a gaseous stream such as an automobile, train, truck or stationary power plant exhaust.

### DETAILED DESCRIPTION OF THE INVENTION

The invention is a catalyst for use on a diesel particulate filter comprising platinum and a cerium oxide wherein the amount, by weight, of platinum present, by volume, in the diesel particulate filter is from about 1 g/ft³ to about 20 g/ft³, the amount, by weight, of cerium oxide present in the diesel particulate filter is at most about 750 g/ft³, and the platinum and cerium oxide are present in a ratio of about 10 to about 75 by weight within the diesel particulate filter. To be clear, the volume of the diesel particulate filter above means the unit volume of the filter including, for example, the volume of the channels in a honeycomb filter, which is the conventional usage in the art.

Even though the ceria may be present in an amount of up to 750 g/ft³, it is preferred that the amount of ceria is at most about 500 g/ft³, more preferably at most about 400 g/ft³, even more preferably at most about 350 g/ft³ and most preferably at most about 300 g/ft³ to preferably at least about 50 g/ft³, more preferably at least about 100 g/ft³ and most preferably at least about 200 g/ft³. Similarly, even though the platinum may be present in an amount of about 20 g/ft³, it is preferred that the amount of platinum is at most about 15 g/ft³, more preferably at most about 10 g/ft³, and most preferably at most about 8 g/ft³ to preferably at least about 2 g/ft³.

Likewise, even though the ratio of ceria to platinum may be up to 75 by weight, to the ratio is preferably at most about 70, more preferably at most about 65, even more preferably at most about 60 and most preferably at most about 50 by weight. Of course, it is understood, that the amount of ceria and ratio of ceria to platinum have an inter-related effect and, as such, each needs to be considered when selecting the amount and ratio. Nevertheless, generally, as the amount of ceria is decreased, the ratio is desirably lower.

The catalyst may be used in any known filter material useful to make a Diesel particulate filter. Filter materials include, for example, cordierite, silicon carbide, silicon nitride and mullite. It is preferred that the filter substrate is mullite and in particular a mullite having an acicular microstructure, because, it has been found that this type of structure may aid in the reduction of the balance point temperature. Examples of such acicular ceramic filters include those described by U.S. Pat. Nos. 5,194,154; 5,173,349; 5,198,007; 5,098,455; 5,340,516; 6,596,665 and 6,306,335; U.S. patent application Publication 2001/0038810; and International PCT publication WO 03/082773.

In a more preferred embodiment of the invention, the ceria is deposited with a second oxide that is an oxide of Hf, Zr, Ti, a rare earth other than cerium, or combination thereof. Preferably, the second oxide is zirconia. Preferably, the second oxide is present in solid solution with the ceria. When a rare earth oxide is used, the rare earth oxide is preferably an oxide having a rare earth metal selected from the group consisting of Pr, Nd, Tb and combination thereof.

The amount of ceria to the second oxide, when present, should be in amount from about 0.1 to about 0.9 times the amount of ceria present by weight. Preferably, the second oxide ratio is at least about 0.2, more preferably at least about 0.3, most preferably at least about 0.4 to preferably at most about 0.8, more preferably at most about 0.7 and most preferably at most about 0.6 times the amount of ceria present by weight.

The ceria and/or ceria plus second oxide is desirably present as small particulates typically having a surface area of at least about 2 m²/g as determined by BET gas adsorption. Preferably the surface area of the ceria and/or ceria plus second oxide is at least about 5 m²/g, more preferably at least about 20 m²/g, most preferably at least about 20 m²/g to typically at most about 500 m²/g.

In addition to the amount of ceria and second oxide deposited, a portion of the ceria and/or second oxide may be present in the Diesel particular filter filter is acicular mullite, the ceria and/or second oxide may be present in the mullite grains or in a glassy grain boundary phase.

The catalyst components (i.e., platinum, ceria, and second oxide) may be deposited upon the ceramic filter by any suitable method such as one known in the art. For example one or more of the catalyst components may be deposited by a method such as described in U.S. Pat. Nos. 4,515,758; 4,740,360; 5,013,705; 5,063,192; 5,130,109; 5,254,519; 5,993,762 and; U.S. patent application Publications 2002/0044897; 2002/0197191 and 2003/0124037; International Patent Publication WO97/00119; WO 99/12642; WO 00/62923; WO 01/02083 and WO 03/011437; and Great Britain Patent No. 1,119,180. Preferably each of the catalyst components is deposited by precipitating a compound dissolved in a liquid (generally water) containing the metal of the catalyst component (e.g., Pt, Ce, Zr, Hf, Ti, Pr, Nd, Tb) from a solution containing urea. Preferably all of the catalyst components are precipitated from the same solution containing urea. Alternatively and preferably, the catalyst components may be precipitated by contacting the impregnated part having the catalyst components therein with an ammonia containing gas. In another preferred embodiment, the oxide catalyst components are first precipitated followed by the platinum being precipitated.

When precipitating the catalyst components using urea, exemplary platinum compounds include Pt(NO₃)₄ and H₂PtCl₆. Exemplary cerium compounds include Ce(NO₃)₃, Ce(C₂H₃O₂)₃, and Ce₂(CO₃)₃. Exemplary second oxide compounds include zirconyl nitrate, zirconyl chloride, zirconium acetate, zirconium basic carbonate, praseodymium nitrate, neodymium nitrate, terbium acetate, terbium nitrate or combination thereof. Preferably the zirconium compounds include zirconyl nitrate, zirconium basic carbonate or combination thereof. Preferably, the platinum compound is Pt(NO₃)₄. Preferably, the cerium compound is Ce(NO₃)₃, Ce(C₂H₃O₂)₃or combination thereof.

Typically, when depositing the catalyst coating using the urea precipitation method, the catalyst containing solution or solutions are created using an acid to help dissolve one or more of the compounds into an aqueous solution. To this solution, urea is added in a sufficient amount such that upon heating to a temperature for a sufficient time while the solution is maintained in an environment that impedes the evaporation of the liquid, the catalyst components precipitate. Examples of useful acids for dissolving the catalyst components include, a mineral acid (e.g., nitric acid and hydrochloric) and an organic acid (e.g., acetic acid). The temperature used may be any practical temperature, but generally is at least room temperature (e.g., 20° C.) to at most about the boiling temperature of water (e.g., 100° C.). Preferably, the temperature is at least about 40° C. and more preferably at least about 60° C. The time may be any practical time, for example, several minutes to several days.

After precipitating the catalyst components, the now catalyzed filter is, generally, heated in air to dry the filter and then to a higher temperature (calcining temperature) to form the ceria, second oxide and platinum within the filter. Generally, the drying temperature may be any temperature useful to drive off the water without significantly disrupting the coating that has been formed. Drying temperatures may vary over a wide range, but generally, are from about room temperature to 150° C. In addition a vacuum may be applied to aid in drying. The time to dry may be any practical time such as several minutes to several days.

The calcining temperature needed to form the ceria, second oxide and platinum, generally, is at least about 400° C. to about 1600° C. Typically, the temperature is at least about 500° C. to about 1000° C. Generally, the atmosphere needs to contain a sufficient amount of oxygen to form the oxides. Generally, air is suitable to calcine the precipitated components to form the ceria and second oxide and form the platinum. If desired or necessary, another heating in a reducing or inert atmosphere to similar temperatures just described may be performed to facilitate the formation of the platinum metal.

When using the urea precipitation method, it has been found that the coating of the catalyst components is very uniform compared to other techniques. This uniformity may contribute to the unique low balance point temperature achieved by the catalyst composition of this invention. Uniform coating herein means that the coating forms a uniform thin coating on the grains and throughout the filter where the solution or solutions of catalyst components have been applied. Preferably, the concentration of the catalyst components does not deviate much more than about 10% from end to end and from middle to edge where the catalyst has been coated. More preferably, the coating is present throughout the walls of the filter such that from the center of a wall to the exterior of the wall the concentration of the catalyst components does not deviate much more than about 10% in concentration by weight.

### EXAMPLES

### Example 1

A honeycomb is formed from a precursor having an Al/Si stoichiometry of 2.95. The honeycomb is 5.6 inches (14.224 cm) in diameter and 6 inches (15.24 cm) long with a cell density of 200 cells per square inch (cpsi) (31 cells per cm²). The precursor is made by mixing 51 parts by weight of ball clay (Todd Dark grade) with 49 parts by weight of kappa-alumina. The ball clay is dried for 48 hours at 110° C. before use. The kappa-alumina is prepared by heating aluminum hydroxide to 1000° C. for 1 hour. Water and organic binders are added to the mixture of ball clay and alumina to form an extrudable material. The extruded honeycomb is dried, debindered and calcined for 1 hour at 1000° C.

The honeycombs are heated under vacuum to 705° C. At this point, SiF₄ gas is introduced into the reactor at a rate needed to maintain 50 torr pressure until gas uptake is complete. The pressure in the reactor is then raised to 400 torr (53 KPa). The reactor is then heated at 2° C. per minute to 1070° C. When the reactor reaches 1070° C., the heating rate is reduced to 1° C. per minute. Heating continues, while the reactor pressure is maintained at 400 torr (53 KPa) until the reactor temperature has reached 1175° C. The final temperature is held for 30 minutes beyond the point where the evolution of SiF₄ substantially ceases, then the reactor is evacuated and cooled to ambient temperature. The resultant acicular mullite Diesel soot filter is then heated to 1400° C. for two hours in air. The pore volume of the acicular mullite Diesel soot filter walls is 680 ml as determined by water uptake.

A catalyst precursor solution is prepared by dissolving 57.48 grams of zirconium basic carbonate (38% ZrO₂) in 21.30 grams of concentrated HNO₃. When the solution is clear, 200 grams of H₂O and 110.2 grams of Ce(NO₃)3*6H₂O is added, followed by 187.5 grams of an aqueous 8% METHOCEL A15LV (available from The Dow Chemical Company, Midland, Mich.) by weight solution. With stirring, 200 grams of H₂O, 5.234 grams of platinum (IV) nitrate solution (13.37% platinum), and 52.10 grams of urea dissolved in 100 grams of H₂O are added sequentially. Water is added to bring the total volume of the catalyst precursor solution to 660 ml.

The mixture is stirred until homogeneous, then poured uniformly over the top face of the acicular mullite filter that has been placed in an open ZIP-LOC plastic bag. The bag is sealed and the part is allowed to sit for 30 minutes to evenly distribute the solution throughout the part. The sealed bag is placed in a polypropylene bag that is evacuated and heat sealed, which is then placed upright in a hot water bath at 95° C. Weights are placed on the filter in the bags to prevent flotation. After 48 hrs the filter is removed from the water bath and oven dried at 105° C. The dried filter is heated in air to 600° C. over 4 hours, held for 4 hours, then cooled to room temperature over 4 hours to form the catalyzed acicular mullite filter.

The catalyzed acicular mullite filter has about 500 g/ft³ of CeO₂, about 250 g/ft³ of ZrO₂ and 8 g/ft³ of Pt.

### Example 2

An acicular mullite filter is prepared in same manner as described in Example 1. A catalyst precursor solution is prepared in the same manner as described in Example 1 except that the amount of catalyst components are adjusted such that the catalyzed acicular mullite soot filter has about 300 g/ft³ of CeO₂, about 150 g/ft³ ZrO₂ and about 8 g/ft³ platinum.

### Comparative Example 1

An acicular mullite filter is prepared in same manner as described in Example 1. The catalyst is applied by a procedure similar to the one described in U.S. Published patent application 2002/0044897. A solution of zirconium acetate equivalent to 250 g/ft³ ZrO₂ is applied by solution impregnation then dried. A second solution equivalent to 500 g/ft³ CeO₂ is applied by solution impregnation of a 1:1 molar cerium nitrate:citric acid mixture then dried and calcined at 450° C. Finally a diammineplatinum nitrite—ammonium hydroxide solution (50 g/ft³ Pt equivalent) was applied by solution impregnation, dried, then calcined for 2 hrs at 600° C.

The balance point temperature of each of the above Examples and comparative Example catalyzed acicular mullite soot filters without any other catalytic device are determined by a procedure similar to the one described in U.S. Published patent application 2003/0124037. Each of the catalyzed filters of the Examples has essentially the same balance point temperature or is lower than the comparative Example filter's balance point temperature.

1. A catalyst for use on a diesel particulate filter comprising platinum and a cerium oxide wherein the amount, by weight, of platinum present, by volume, in the diesel particulate filter is from about 1 g/ft³ to about 20 g/ft³, the amount, by weight, of cerium oxide present in the diesel particulate filter is at most about 750 g/ft³, and the platinum and cerium oxide are present in a ratio of cerium oxide/platinum of about 10 to about 75 by weight within the diesel particulate filter.

2. The catalyst of claim 1, wherein the catalyst is further comprised of a second oxide of Hf, Zr, Ti, a rare earth other than cerium or combination thereof.

3. The catalyst of claim 2, wherein the second oxide is zirconium oxide.

4. The catalyst of claim 2, wherein the second oxide is in a solid solution with the cerium oxide.

5. The catalyst of claim 2 wherein the amount by weight of the second oxide is about 0.1 to 0.9 times the amount of cerium oxide present in the diesel particulate filter.

6. The catalyst of claim 5, wherein the amount of the second oxide is at most about 0.75 times the amount by weight of cerium oxide present in the diesel particulate trap.

7. The catalyst of claim 6, wherein the amount by weight of the second oxide is at most about 0.5 times the amount of cerium oxide present in the diesel particulate trap.

8. The catalyst of claim 7, wherein the second oxide is zirconium oxide.

9. The catalyst of claim 8, wherein the diesel particulate filter is an acicular mullite.

10. The catalyst of claim 9, wherein at least a portion of the cerium oxide is present in at least a portion of the grain boundaries of the acicular mullite.

11. The catalyst of claim 10, wherein at least a portion of the second oxide is present in at least a portion of the grain boundaries of the acicular mullite.

12. The catalyst of claim 1, wherein the amount of cerium oxide present in the diesel particulate filter is at least about 200 g/ft³.

13. The catalyst of claim 1, wherein the cerium oxide is present in amount within the diesel soot filter of at most about 500 g/ft³.

14. The catalyst of claim 13, wherein the cerium oxide is present as a solid solution with a second oxide, the second oxide being an oxide of Hf, Ti, Zr, a rare earth other than cerium or combination thereof.

15. The catalyst of claim 14, wherein the second oxide is zirconium oxide.

16. The catalyst of claim 1, wherein the amount of cerium oxide is at most about 400 g/ft³.

17. The catalyst of claim 2, wherein the rare earth is Pr, Nd, Tb or combination thereof.

18. The catalyst of claim 1, wherein the catalyst is present as a uniform coating on the grains of the diesel particulate filter.

19. The catalyst of claim 18, wherein the diesel particulate filter is comprised of acicular mullite grains.

20. A Diesel exhaust system comprised of the Diesel soot filter of claim 1.

21. The Diesel exhaust system of claim 20 wherein the Diesel soot filter is located in the exhaust system such that no other catalyst is present upstream of the Diesel soot filter.

22. The catalyst of claim 1 wherein the cerium oxide to platinum ratio by weight is at most about 70.

23. The catalyst of claim 1 wherein the cerium oxide to platinum ratio by weight is at most about 65.

24. The catalyst of claim 1 wherein the cerium oxide to platinum ratio by weight is at most about 60.

25. The catalyst of claim 1 wherein the cerium oxide to platinum ratio by weight is at most about 50.

26. The catalyst of claim 1 wherein the amount of platinum is at most about 15 g/ft³.

27. The catalyst of claim 26 wherein the amount of platinum is at most about 10 g/ft³.

28. The catalyst of claim 27 wherein the amount of platinum is at most about 8 g/ft³.
